(19) United States
(12) Patent Application Publication
(10) Pub. No.: US 2022/0148091 A1
(43) Pub. Date: May 12, 2022

(54) COMPUTERIZED REAL PROPERTY VALUE INVESTMENT SYSTEM AND METHOD

(71) Applicant: Allan N. Weiss, Medfield, MA (US)

(72) Inventor: Allan N. Weiss, Medfield, MA (US)

(21) Appl. No.: 17/454,047

(22) Filed: Nov. 8, 2021

Related U.S. Application Data
(60) Provisional application No. 63/110,411, filed on Nov. 6, 2020.
(60) Provisional application No. 63/127,916, filed on Dec. 18, 2020.
(60) Provisional application No. 63/133,520, filed on Jan. 4, 2021.

(51) Int. Cl. G06Q 40/06; G06Q 20/38; G06Q 30/02

(52) U.S. Cl. CPC G06Q 40/06; G06Q 30/0206; G06Q 20/389

(57) ABSTRACT

A computerized equity investment management method comprises, in a networked computer system having at least one processor, generating a digital ledger and storing a property identification, a property owner identification, and an existing loan amount therein; determining a market value for the subject property and storing the market value in the digital ledger; and calculating an equity investment amount that is not greater than the market value less the loan amount. The method further includes conducting an equity investment transaction, comprising defining a term and an index representing a change in the market value of the subject property; transferring the equity investment amount from an investor account to an account associated with the property owner identification; and updating the digital ledger. At a term end, the method includes calculating an investor payout as an index adjusted equity investment amount.

### CROSS REFERENCE TO RELATED APPLICATIONS

The present application claims priority to U.S. Provisional Patent Application 63/110,411 filed Nov. 6, 2020, entitled COMPUTERIZED REAL PROPERTY VALUE SHARING SYSTEM AND METHOD, U.S. Provisional Patent Application 63/127,916 filed Dec. 18, 2020, entitled COMPUTERIZED REAL PROPERTY VALUE SHARING SYSTEM AND METHOD, and U.S. Provisional Patent Application 63/133,520 filed Jan. 4, 2021, entitled COMPUTERIZED REAL PROPERTY VALUE SHARING SYSTEM AND METHOD, each of which is incorporated by reference herein.

### FIELD OF INTEREST

The present inventive concepts relate to the field of computer-based systems useful for electronically organizing, processing, and storing data, such as data related to one or more real property, and organizing, processing, and storing data associated with such properties, including data representing various forms of ownership, mortgage loans, and other claims against the properties, including cash flows, residual value, and rights of use or control. Such computer-based methods advance current technology by performing automated aggregation, analysis, processing, recording, and communication of data for transferring record of ownership of such rights, along with data related cash payments or payments in kind, and displaying of such data and data-driven graphics in a manner that computer systems heretofore were incapable of accomplishing. The inventive systems and method, because of the volume, aggregation from different sources, access from different systems, and for other reasons, is practically limited to a computer environment comprising a network of computer systems and devices.

### SUMMARY

In accordance with various aspects of the inventive concepts, provide is a system and method for a real property value investment method. A networked computer system is provided that implements a method that accesses multiple systems to achieve the inventive concepts.

According to an aspect of the inventive concepts, provided is a real property value investment method. The method is a computerized equity investment management method that utilizes one or more computer processors and systems accessing at least one storages device. Various functions and components can be distributed, with processors and/or systems communicating electronically over computer networks. The method can be carried out by the systems and, as a practical matter, will interface over one or more networks with other systems and information sources, at the least.

In various embodiments, the at least one processor, for each of a plurality of subject properties, generates a digital ledger to store property information in the at least one storage device, including storing a property identification, a property owner identification, and an existing loan amount associated with a subject property in the digital ledger. The at least one processor electronically determines a market value for the subject property and stores the market value in the digital ledger.

The at least one processor calculates an equity investment amount that is not greater than the market value less the loan amount. That is, the system is configured to determine the amount of equity in the subject property so that the magnitude of the investment opportunity can be determined. In some embodiments, the investment amount can be less than the equity amount. But in other embodiments, the investment amount can be equal to the equity amount. In still other embodiments, the inventive concepts may allow the investment amount to be greater than the equity amount, particularly if appreciation if likely before the end of the term.

With an equity investment amount established, parameters are determined for conducting an equity investment transaction. The parameters can be electronically presented to the property owner and one or more potential investors. Once agreement between the property owner and an investor is indicated to the system, e.g., through electronic signatures, or other indicia of agreement, the method continues to electronically conduct the equity investment transaction.

The method defines a term and an index representing a change in the market value of the subject property. Assuming agreement and commitment electronically indicated to the system, the equity investment amount can be electronically transferred from an investor account to an account associated with the property owner identification.

The digital ledger can be updated to associate an investor identification, equity investment amount, term, and index with the subject property as an equity investment. An investor payout can be calculated as an adjustment of the equity investment amount by the index at a term end.

At any point during the method, the digital ledger can be updated to be kept current. Also, the system and method can generate computer displays presenting data and information from and/or based on the digital ledger. The computer displays can include the equity investment amount, the term, and the index, as examples. The system and method could also allow the property owner to login at any time and determine an investor payout amount in real time.

In various embodiments, according to the method, the digital ledger can be a distributed digital ledger having property information distributed across a plurality of storage devices. In various embodiments, the system and method can encrypt the digital ledger.

In various embodiments, according to the method, the at least one processor can calculate a loan to value (LTV) ratio for the subject property as a ratio of the existing loan amount to the market value. And the method can compare the calculated LTV to a threshold LTV and if the calculated LTV exceeds the threshold LTV, the method can terminate before calculating the equity investment amount. In various embodiments, the LTV threshold can be eighty percent, as an example.

In various embodiments, transferring the equity investment amount from the investor account to the account associated with the property owner identification includes the at least one processor calculating an escrow amount as a multiple of monthly mortgage payment associated with the loan amount and transferring the escrow amount, as at least a portion of the equity investment amount, to an escrow account. In various embodiments, the method further comprises the at least one processor, in response to a communication from a mortgage lender system of a past due mortgage loan payment, electronically transferring an amount equal to the past due mortgage loan payment from the escrow account to a mortgage lender system.

In various embodiments, electronically determining the market value for the subject property comprises the at least one processor: generating an electronic query to an automated valuation system requesting the market value for the subject property; receiving an electronic response including a received automated valuation market value; and storing the received automated valuation market value as the market value in the digital ledger.

In various embodiments, electronically determining the market value for the subject property comprises the at least one processor: querying remote systems comprising property sales and/or listing data for properties comparable to the subject property, wherein determining comparable properties includes identifying properties have having similar listing attributes within a zip code; and calculating the market value from the sales and/or listing data for the properties comparable to the subject property.

In various embodiments, the similar listing attributes can include a number of bedrooms, a number of bathrooms, and a dwelling type, wherein the dwelling type can be chosen from a group consisting of single family, multi-family, condominium, and cooperative.

In various embodiments, the method further comprises the at least one processor: for each of one or more of the subject properties, defining a share representing the equity investment associated with the subject property; associating the share with the digital ledger for the subject property; and hosting an online trading platform to offer, buy, and sell of the shares. The method can further comprise the at least one processor updating the digital ledger with a new investor identification in response to a sale of share by a new investor.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1 is a block diagram depicting interconnectedness and relationships among various systems that can communicate, share data, and co-process information with a real property value investment system, in accordance with aspects of the inventive concepts.

FIG. 2 is a block diagram of a real property value investment system, in accordance with aspects of the inventive concepts.

FIG. 3 is a flow diagram of an embodiment of a real property value investment method, in accordance with aspects of the inventive concepts.

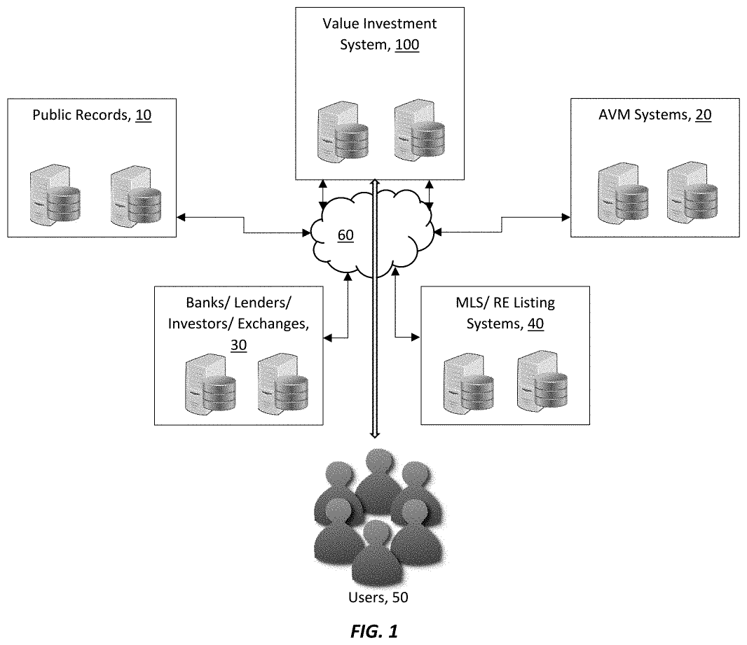

The diagrams of FIGS. 1, 2, and 3 are not intended to be limiting of the inventive concepts.

### DETAILED DESCRIPTION OF PREFERRED EMBODIMENTS

Various aspects of the inventive concepts will be described more fully hereinafter with reference to the accompanying drawings, in which some exemplary embodiments are shown. The present inventive concept may, however, be embodied in many different forms and should not be construed as limited to the exemplary embodiments set forth herein.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

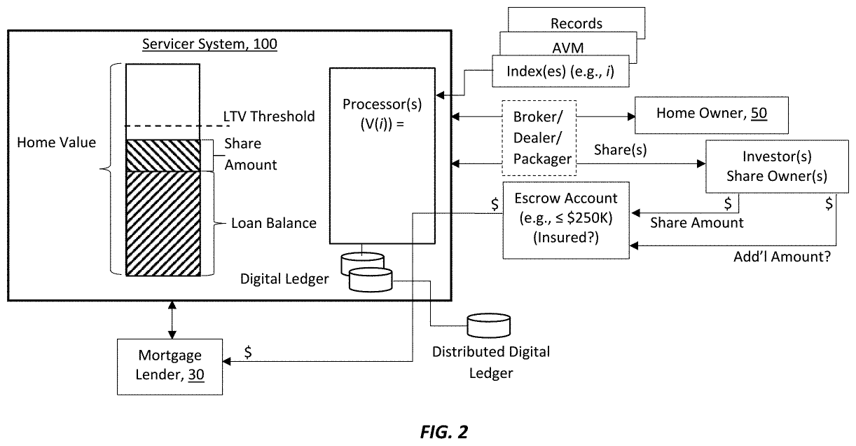

To the extent that functional features, operations, and/or steps are described herein, or otherwise understood to be included within various embodiments of the inventive concept, such functional features, operations, and/or steps can be embodied in functional blocks, units, modules, operations and/or methods. And to the extent that such functional blocks, units, modules, operations and/or methods include computer program code, such computer program code can be stored in a computer readable medium, e.g., such as non-transitory memory and media, that is executable by at least one computer processor. See FIGS. 1 and 2 has examples of functional relationships among interconnected systems useful in various embodiments of the inventive concepts.

FIG. 1 is a block diagram depicting interconnectedness and relationships among various parties and systems that can electronically collaborate with a real property value investment system, in accordance with aspects of the inventive concepts. The relationships and systems are representative. In other embodiments, the roles of various systems and entities could be combined or omitted.

FIG. 2 is a diagram of a real property value investment system 100, in accordance with aspects of the inventive concepts. In various embodiments, the system 100 can implement a real property value investment method with capabilities for originating and/or representing a debt, equity, or other stakes in real property (or other asset); identifying the asset itself, the owner or owners of the asset, and/or the owners of each debt, equity, or other stake in the asset; changing the owner of record of any of the stakes in the asset; calculating and recording payments required of the asset owner as a result of any of the stakes, e.g., from the owner of the asset to the owner of record of the stake; and/or recording events related to the value of the asset or any of the stakes in the asset to assist potential buyers or sellers in establishing a fair market value of the stakes or the asset. In accordance with various aspects of the inventive concepts, the foregoing is further described in the various embodiments below.

The diagrams of FIGS. 1 and 2 are not intended to be limiting of the inventive concepts. As will be discussed with respect to various embodiments below, systems and methods in accordance with the inventive concepts can include the possibility of more than one mortgage, more than one ownership interest, and/or non-ownership rights, such as right to live in the home and/or control the home, without certain ownership responsibilities, such as paying taxes, insurance, and/or maintenance related to the property. Furthermore, there may be a time element associated with the various rights and/or obligations related to a property, e.g., certain rights can vest or expire at certain times and/or certain obligations can become due or cease to be required at a certain time.

FIG. 1 is a diagram of systems that can cooperatively perform a real property value investment method. The systems include a real property value investment system 100, in accordance with aspects of the inventive concepts. Complimentary systems and data sources interface with system 100 to provide data and functionality to the system and its users. As will be appreciated by those skilled in the art, such complimentary systems and data sources can include, but are not limited to, public record system 10 (e.g., town, county, and or state systems with property related data, such as tax data); auto-valuation method (AVM) systems 20 used to determine values of properties, systems 30 of banks, lenders, investors and/or exchanges; real property listing systems 40, such as the multi-listing service (MLS), and various systems and devices used by users to access and interact with the value share system 100, such as personal computers, tablets, mobile phones, and the like. In various embodiments, the system 100 generates computer displays for rendering on user devices 50 and/or any one or more of the systems, that enable the functions described herein. User devices and/or systems can include, but are not limited to, a mobile phone, a tablet, a phablet, a laptop, and/or a desktop computer.

The various system can communicate over at least one network 60. Such networks can include, but are not limited to, the Internet, World Wide Web, virtual private networks, cellular networks, WiFi networks, and/or any other type of known or hereafter developed network.

Referring to FIG. 2, the real property value investment system 100 includes processors, data storage devices, and executable computer program code necessary to execute the various functions and combinations of functions discussed above and otherwise reasonably understood to be necessary or useful to support such functions. As envisioned, the functions are necessarily performed in a computing environment that can push, pull, aggregate, and otherwise process data over one or more of a variety of networks. In various embodiments, the system 100 can be equipped with one or more processors and databases or data sources that collectively obtain, store, manage and process data used to electronically manage assets, stakes in assets, and relationships among stakeholders, electronic funds transfers, and compute the value of stakes in assets, interest, or changes in investments (e.g., investment performance) (V(i)) (collectively, a “value-sharing stake”).

These computations can use, as an input, at least one index representing a current or forecasted value of a subject real property, e.g., a residential property, that is the basis or subject matter of the asset value sharing relationship. The index (or indexes) can change with time, thereby causing the value of one or more stakes in an asset, and/or one or more payments associated therewith, to responsively adjust. In some cases, the one or more indexes can include or consist of a property specific index. For example, if the subject property were 123 Main Street, Anytown, USA, an index used could be representative of that specific property. In some embodiments, a system implementing at least one automated valuation model (AVM) can be accessed or used for obtaining or determining an index. In some embodiments, records with data useful for determining a value of the property can be accessed by the system 100 for determining an index.

In the embodiment of FIG. 2, the system 100 can be referred to as a “servicer” system, wherein the servicer is an entity that uses system 100 to initiate or facilitate, record, manage, aspects of the method of value investment in a subject real property asset. The system 100 can be configured to include or access data used to compute or otherwise determine the value of the property and the balance of the mortgage for the property, e.g., at that time. The system can implement a max loan-to-value (LTV) ratio to help determine the possible available amount to be used to sell an interest or stake in the property to another. In such a case, preferably, the threshold LTV would not be exceeded by the amount of the available stake when added to the mortgage loan balance. For these purposes, the system 100 can be configured to communicate with the mortgage lender, e.g., holder of a first mortgage on the subject real property. Although, in some embodiments, the lender and servicer can be the same entity.

The present invention is not limited to the embodiments of FIGS. 1 and 2, as will be clear from the description herein. Other relationships and configuration, combination, and/or separation of roles may be possible in various embodiments.

Description of a Value-Investment Mechanism

Record the Entire Capital Structure of a Piece of Real Estate (or anything else) in a Single Ledger or Distributed Ledger

A potential use for a value investment mechanism, e.g., stake in real property, is to help homeowners who cannot pay their mortgages, turn equity into cash so they do not have to sell or default. As situations change and evolve, the value investment system and method may have other applications.

In various embodiments, the value investment system is configured to record part or all of the entire Capital Structure of a piece of real estate (or anything else) in a single ledger or distributed ledger represented in computer memory by one or more data structures, records or files. If such recordings include more than one data structure, record or file, those are logically related to form a single capital structure ledger with portions stored in different computer locations. An interest in the value investment opportunity can be represented in a “share”—or stake in or related to the subject property. In various embodiments, the ownership structure can also include intellectual property rights, such as the right to use a house specific price index, AVM or other metric of value or value change associated with the property including the rights to use, view, share, value or settle up a share right (or stake) in the subject property using such intellectual property.

Within the value investment system, the set of rights and obligations associated with the real estate property can be electronically stored and referenced in various data type forms, such as in a deed, trust deed, lien, deed restriction, or other public recording electronically represented and stored as well as other legally enforceable rights that are not recorded in public records, e.g., in public records system 10. These different data type forms can comprise elements of the capital structure ledger for the property, whether stored in a single computer storage location or distributed, and in one such form in a decentralized distributed ledger. Reference in the public records can be to a distributed decentralized ledger or distributed database (“Database”), in some embodiments, so that the public record and the decentralized ledger or distributed database are connected and re-enforce the functionality and value of both systems of records, such as referring in the public record to the Database rights so the public is on notice of such rights, creating legally enforceable rights recorded in the Database through this reference to the public records, creating insurance coverage, such as title insurance recorded in the public record that insures to the benefit of parties whose interests are recorded in the Database.

Elements of capital structure can be debt, equity, contract, indexed contract, option, represented in the stored capital structure ledger, as examples. In various embodiments, these can include rights or obligations pertaining to the real estate/house (real property). As examples, these can include a right to live in the house and control it physically (as to who lives there, maintenance, changes, improvements), the right to fund a mortgage servicing account at a bank in which the cash is used to pay part or all of one or a series of mortgage payments to the mortgage lender or their mortgage servicer, the right of a bank to open such an account for the benefit of a homeowner to be used to pay mortgage payments on behalf of the homeowner and according to bank regulator rules, the right to deduct mortgage interest payments from the taxable income by the party that funds an account from which mortgage interest is paid. Rights to control real estate would normally be associated with obligations to maintain the house physically, pay for taxes and insurance, maintain records of timing and existence of insurance, see the insurance policy, and/or pay some or all debt obligations on the house. If someone received cash in exchange for a value investment in a property, this cash, or at least a portion of it, could be directed by the system 100 to pay the mortgage on the property. Within this structure, the system 100 can add assets tied to this property (or parcel), such as a bank account with a proscribed payment stream to the mortgage holder, e.g., unemployed or underemployed people could use the value investment stake or share to access equity and use the cash received in exchange for the stake in the property to pay their mortgage, e.g., while they look for a job.

The system 100 can also be configured to use the price paid for the value investment stake in the property, which is an asset, in combination with a price index to calculate a value, pay-off amount, or valuation for the stake (or asset). When a stake in a property is purchased by an investor in the property, the property owner and investor each have an interest in the property that can be determined and fluctuate according to a relevant index, such as an index representing a market value of the property, for example.

Beneficial Applications

By implementing the value investment mechanism, with the computerized capital structure ledger, homeowners and investors can realize a variety of benefits not available in computerized systems for recording, managing, and displaying value aspects of one or more real properties, such as homes. Such benefits can include one or more of: the ability to record and thereby facilitate the creation of and trading of ownership interests, mortgages, claims, stakes or other rights in real property, including recording transaction dates, amounts paid, buyer and seller of each component in a set of claims on a property, bundle multiple assets for cross-collateralization; can use the data to calculate price indexes and store them in the database so every house has one or a set of price indexes that are used to determine the cash flow waterfall described in the Common Index Securities Patents, which are incorporated herein by reference. Indexes would be more timely since a lag to record, key, and report would be eliminated and it would be more accurate with no errors in data and maintenance records; indexes would be more accurate because could see all the claims and if they are current (or potentially even if late on loan payments) to determine if price was arms-length and therefore accurate to market value; and/or could gain price discovery of consumption benefits of living in the house versus investment return because the consumption less costs of ownership would be a bundle that could be bought and sold separate from the value of potential changes in value. In some embodiments, this is particularly possible if the right to live in the property is time-bound (e.g., like rent). Other embodiments will allow the segmenting of claims from fewer payments to more payments creating a waterfall of cashflows or other rights so that certain owners are paid sooner and perhaps face less risk and other investors are paid later and face larger risk, but with larger potential return. Still other embodiments will allow the aggregating of cashflows from several claims in one or more properties into a larger pool of claims, creating a larger more diversified portfolio which may enhance liquidity of such interests.

For example, if you buy the whole thing for $1M and then agree to pay the price appreciation of the whole thing for the next 30 years and you get $500,000 for this, then your net cost to live there for the next 30 years is $500,000. Then in 30 years, if you sell the whole thing for $1.5 million, you pay $1M to the party who bought the appreciation, and you receive $500 k. Therefore, the cost to live in the home for the 30 years was the interest on the $500,000, not the $500,000.

In various embodiments, the database can be adapted to what is now done to pool payments of mortgage payments into mortgage-backed securities and pay them out in tranches (mortgage-backed securities) replace a single purpose vehicle for each pool of mortgages (this way one mortgage could by itself provide cashflows to many pools instead of one single purpose vehicle holding whole mortgages.

Using the system 100, one can see aggregated data on how late people are in paying their mortgages giving the market more advanced warning of economic stress developing by locality or market segment. This system would allow owners to receive cash for the sale of covered call option on the houses so that if the house index goes up by more than a defined threshold the option buyer is paid the amount over the threshold. These contracts can stay in place even when the owner occupant sells so the investor knows they have this right for 30 years and this makes it less expensive for the owner occupant to enjoy the consumption benefits of living on the house.

This present invention makes such an arrangement realistically efficient because it can be used to separate ownership of the consumption benefits of living in the house from option, debt or equity claim on the house, with time spans of any of these interests that may begin when one party is the owner occupant but live on after such party sells their interest to another owner occupant. Normally, debt claims are extinguished when an owner sells the home. The system would allow for what is not efficiently possible now given the limited set of legal claims it is now possible to realistically record in the public records: a computerized easily recorded, queried and confirmed way to flexibly create any sequence of rights, with flexible timing of payments, indexing of payments, payment amount thresholds, formulas and payment triggers such that traders, investors and homeowners may, through negotiation, experimentation, artificial intelligence, or other means, determine a form or multiple forms of interest in one or more parcels of real property or other asset that form part or all of the capital stack of an asset, and record of the entire capital stack.

In various embodiments, this system 100 would enable keeping a 30-year agreement in place, let the owner sell 30 years of appreciation, lowering the risk and cost of ownership.

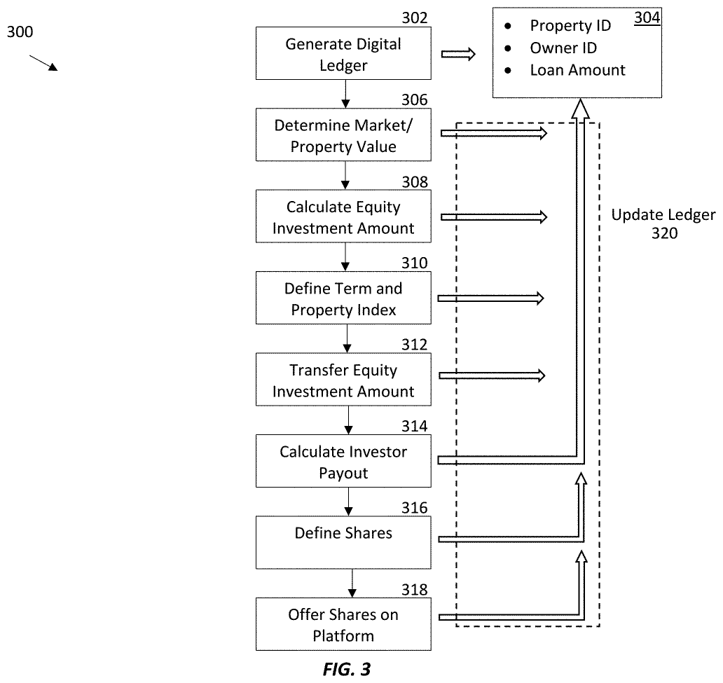

FIG. 3 is a flow diagram of an embodiment of a real property value investment method 300, in accordance with aspects of the inventive concepts. The method 300 is a computerized equity investment management method that utilizes one or more computer processors and systems accessing at least one storages device. Various functions and components can be distributed, with processors and/or systems communicating electronically over computer networks. The method can be carried out by the systems of FIGS. 1 and 2 and, as a practical matter, will interface over one or more networks with other systems and information sources, at the least.

Referring to FIG. 3, in various embodiments, the at least one processor, for each of a plurality of subject properties, generates, in step 302, a digital ledger 304 to store property information in the at least one storage device, including storing a property identification, a property owner identification, and an existing loan amount associated with a subject property in the digital ledger. In step 306, the at least one processor electronically determines a market value for the subject property and stores the market value in the digital ledger.

In step 308, the at least one processor calculates an equity investment amount that is not greater than the market value less the loan amount. That is, the system is configured to determine the amount of equity in the subject property so that the magnitude of the investment opportunity can be determined. In some embodiments, the investment amount can be less than the equity amount. But in other embodiments, the investment amount can be equal to the equity amount. In still other embodiments, the inventive concepts may allow the investment amount to be greater than the equity amount, particularly if appreciation if likely before the end of the term.

In step 310, with an equity investment amount established, parameters are determined for conducting an equity investment transaction. The parameters can be electronically presented to the property owner and one or more potential investors. Once agreement between the property owner and an investor is indicated to the system, e.g., through electronic signatures, or other indicia of agreement, the method continues to electronically conduct the equity investment transaction. In step 310, the method defines a term and an index representing a change in the market value of the subject property. Assuming agreement and commitment electronically indicated to the system, in step 312, the equity investment amount can be electronically transferred from an investor account to an account associated with the property owner identification. The digital ledger can be updated to associate an investor identification, equity investment amount, term, and index with the subject property as an equity investment. In step 314, an investor payout can be calculated as an adjustment of the equity investment amount by the index at a term end.

At any point during the method, the digital ledger can be updated to be kept current. Also, the system and method can generate computer displays presenting data and information from and/or based on the digital ledger. The computer displays can include the equity investment amount, the term, and the index, as examples. The system and method could also allow the property owner to login at any time and determine an investor payout amount in real time.

In various embodiments, according to the method, the digital ledger can be a distributed digital ledger having property information distributed across a plurality of storage devices. In various embodiments, the system and method can encrypt the digital ledger.

In various embodiments, according to the method, the at least one processor can calculate a loan to value (LTV) ratio for the subject property as a ratio of the existing loan amount to the market value. And the method can compare the calculated LTV to a threshold LTV and if the calculated LTV exceeds the threshold LTV, the method can terminate before calculating the equity investment amount. In various embodiments, the LTV threshold can be eighty percent, as an example.

In various embodiments, transferring the equity investment amount from the investor account to the account associated with the property owner identification includes the at least one processor calculating an escrow amount as a multiple of monthly mortgage payment associated with the loan amount and transferring the escrow amount, as at least a portion of the equity investment amount, to an escrow account. In various embodiments, the method further comprises the at least one processor, in response to a communication from a mortgage lender system of a past due mortgage loan payment, electronically transferring an amount equal to the past due mortgage loan payment from the escrow account to a mortgage lender system.

In various embodiments, electronically determining the market value for the subject property comprises the at least one processor: generating an electronic query to an automated valuation system requesting the market value for the subject property; receiving an electronic response including a received automated valuation market value; and storing the received automated valuation market value as the market value in the digital ledger.

In various embodiments, electronically determining the market value for the subject property comprises the at least one processor: querying remote systems comprising property sales and/or listing data for properties comparable to the subject property, wherein determining comparable properties includes identifying properties have having similar listing attributes within a zip code; and calculating the market value from the sales and/or listing data for the properties comparable to the subject property.

In various embodiments, the similar listing attributes can include a number of bedrooms, a number of bathrooms, and a dwelling type, wherein the dwelling type can be chosen from a group consisting of single family, multi-family, condominium, and cooperative.

In various embodiments, the method further comprises the at least one processor: for each of one or more of the subject properties, defining a share representing the equity investment associated with the subject property; associating the share with the digital ledger for the subject property; and hosting an online trading platform to offer, buy, and sell of the shares. The method can further comprise the at least one processor updating the digital ledger with a new investor identification in response to a sale of share by a new investor.

Below is an example process that could be implemented by an embodiment of the system and method.

### EXAMPLE

Buy entire house for $1 million
Sell right to receive $500,000 adjusted by similar house index in 30 years
While living in the house, the owner of this value investment stake can divide it into a return of up to 3% and a return of over 3%, which can be further subdivided
Sub-divisions do not affect total amount to be paid by owner occupant, just who gets the money at the end
An owner-occupant can sell its rights after only 5 years and the other 30 year interest(s) stays in place
An owner-occupant can also buy these interests back any time they want at the market price, which can be determined by the system 100 using at least one index
The amounts should add up to the total value of the house
The price used to calculate the price index of the house is the change in value of the owner-occupied piece; in some embodiments, the system can normalize houses with different expiration dates when the rest of the equity payments are due
In some embodiments, the system can calculate the value adjustment so a house sold with 1 year left can be understood in the same terms as a house with 30 years left (which otherwise might be deemed more valuable since there is less uncertainty). This is similar to the increase in value of a house with below market financing
The value investment system can accomplish the recordings, adjustments, and communicating associated with the above functions.

Applications of the Mechanism

The system 100 can be applied to electronically record, manage, track, enable and display the buying, selling, pricing, and other aspects of ownership between investors and/or lenders and homeowners or owners of other assets. The information can be updated, adjusted and present in real time. Historical data, comparative data, and/or forecasted data related to the property and/or the ownership interests can be displayed.

In various embodiments, the system 100 can enable and/or allow one to record a value investment stake (as a unit of interest) on the property (e.g., house).

In various embodiments, the system 100 can enable and/or allow one to record the owner of record of a value investment stake when it changes hands so a system administrator, manager, and/or stakeholder knows who to send a price index or other information to so they can track the value of their ownership interests, or obligations, to record a stack or waterfall of value investment stakes.

In various embodiments, the system 100 can enable and/or allow one to record any combination of rights and obligations in any waterfall with any triggering events for payments or changes in rights, obligations of the house, various stakes in the house or assets such as an escrow account to be used to pay certain expenses of the house, which can replace title insurance.

In various embodiments, the system 100 can enable and/or allow one to see claims not publicly recorded, typically, e.g., tax liens.

In various embodiments, the system 100 can enable and/or allow one title policy to covers many or all future claims for at least one property.

In various embodiments, the system 100 can enable and/or allow one to sell rights and obligations (or stakes) normally associated with the owner, while keeping other claims in place so the home is more affordable.

In various embodiments, the system 100 can enable and/or allow one to record all maintenance records in one place for more accurate information on property condition.

In various embodiments, that system 100 can enable and/or allow a single slice of interest, such as a percent of equity, to be broken up flexibly and continuously without need for additional public record recordings.

In various embodiments, the system 100 can enable and/or allow all owners to easily see assets and other interests they have in real-time (e.g., and where they rank in waterfall). The system could also generate and communicate triggers for payments.

In various embodiments, the system 100 can enable and/or allow one party to manage cash flows and/or the system can be programmed to manage cashflows using a distributed ledger.

In various embodiments, the system 100 can enable and/or allow reduced costs of servicing mortgages and other claims, e.g., and tracking timely payments of taxes and insurance.

In various embodiments, the system 100 can enable and/or allow one to monitor property maintenance for insurance, lender, and other stakeholders.

In various embodiments, the system 100 can enable and/or allow one to purchase a diversified portfolio of home equity interests (or stakes) to be recorded on a ledger, e.g., no reason to hold one equity piece in a special purpose vehicle (SPV) and off the ledger record who owns each share of the SPV.

In various embodiments, the system 100 can enable and/or allow one to distribute cash directly off this ledger to other owners.

In various embodiments, the system 100 can enable and/or allow any combination of interests to be traded in any sort of bundle.

In various embodiments, the system 100 can enable and/or allow one to include land, air rights, short term rentals, long term rentals, easements, asset pledges, guarantees on notes as assets or interests.

In various embodiments, the system can enable and/or allow one to include houses listed for sale or any of the rights listed for sale, so can also define and host an online marketplace. In various embodiments, this can be tied to: an existing distributed network to get it going quickly; an existing tokenized system like bitcoin; and/or etherium smart contracts. For example, in some embodiments, payments could be made with tokens. For example, in some embodiments, access to this ledger could be paid for with system (e.g., value investment) tokens.

If an investor has certain rights to the property (e.g., house), the investor can have the associated rights to the indexes needed to see the value of the property and/or the value investment asset (or stake). The system 100 can also enable trading, e.g., buying and selling, of value investment assets (or stakes). In such a case, the system 100 can implement a trading platform for the value investment assets in properties.

In various embodiments, the system 100 can enable immediate financing related to a value investment asset (or stake) in a subject property, e.g., in real-time or at least faster than is now possible.

In various embodiments, the system 100 can enable and/or allow instant property and/or value investment asset valuations, e.g., in real-time, e.g., using stock arial photos, condition of the property, and other information indicative or property condition or value. In various embodiments, the homeowner could upload photos or condition scores for use in obtaining a valuation.

In various embodiments, the system 100 can enable and/or allow efficient asset preservation of houses in distress or owned by banks.

In various embodiments, the system 100 can be useful for investors, economists, regulators, banks to see a plurality of different types of information from different sources, all at once, in real-time for a property. This can include every listing, trade, and/or improvement and, for example, which can make investors aware of local market trouble spots where more people are defaulting on mortgages. This information could be beneficial to create subsidies to help buttress home prices to prevent price decline contagion in those troubled areas.

### Further Embodiments, Features, and Applications

The pandemic of 2020 induced a mortgage crisis in which about 5 million people could not pay their mortgages and the federal government-imposed orders preventing banks from foreclosing on past due mortgage loans, so instead the loans were put in “forbearance.” The past due payments accumulated over time and remained past due, but during this time the home owners were not in default. Eventually, forbearance was scheduled to cease at the end of January 2021, but was extended for a limited amount of time in view of the magnitude of the problem. In the long run, this problem cannot be ignored—either the bank loses money or homeowner pays up.

But unlike the last mortgage-related financial crisis, most homeowners have a lot of equity. It's just that many owners did not have a way to use this equity to cover the mortgage without the homeowner being forced to sell the house. Homeowners could not borrow on their home equity if they are delinquent on the existing mortgage. However, the inventive concepts enable homeowners to take cash out of the equity using a value investment mechanism that is equity-like rather than debt, with no monthly payments.

In some embodiments, value investment mechanism can be implemented as a solution for homeowners in forbearance (and their lenders). In some embodiments, value investment stake can be used as first-time homebuyer down payment assistance, since if prices fall, the value investment stake goes down, which protects the homeowner's equity and therefore maintains the motivation to keep paying rather than strategically defaulting. Value investment stakes can be used, therefore, for the purpose of using equity in someone's home to solve for forbearance, or for any other cash crunch, while keeping the homeowner in the home without requiring a sale of the property or loan default.

Under one model, banks and other “originators” of value investment stakes (which can be in the form of investment shares), referred to as “Packagers,” can issue and maintain value investment shares representing the investor's stake in the property.

One application is directed to assisting homeowners who are in forbearance and cannot pay their mortgage. In various embodiments, the inventive concepts can be implemented to provide enough cash to a home owner to pay the back the amount due (the “forborne” amount) plus put in escrow another 12 months of payments. This means the mortgage is guaranteed to start current and stay current for a year while the homeowner looks for another job, for example, or otherwise resolves the issue causing non-payment. If the average homeowner has a current LTV (loan-to-value ratio) of 50%, was paying 6% per year in monthly mortgage, taxes and insurance payments, and stopped paying in April, they are 9 months late or 4.5% of house value. Another year would require another 6% to bring the value investment shares percent of house value to 10.5%. So, if starting LTV was 50% their ending LTV would be 60.5% less amortization of about 2%. If appreciation is 3% then the value investment shares increase would be about 7%, where average value investment share cash contribution over the course of the year is a multiple of 2×3%=0.42%. So, the net equity increase is 3%−0.42%=2.6%. Therefore, all in, the homeowner LTV went up +2% amortization+2.6% net appreciation, less 10.5% value investment share=about 6%. The new LTV is therefore 56%.

Daisy Chained Value Investment Shares

In one embodiment, most investors will initially be worried about liquidity. They want a short-term value investment, e.g., probably a year, since there is no liquid market as of yet for value investment shares. If the homeowner gets a job in the next year, they will likely be able to begin repaying their mortgage and repay the investor with additional proceeds from an increased mortgage balance. But there is a big risk the homeowner will need more time and cannot repay. If that happens, the investor wants to know they can “foreclose” and take the house, get their money out, repay the first mortgage and give the homeowner the remainder. Of course, the homeowner would feel a lot more secure if they knew they had more time no matter what. The goal of the inventive concepts is to satisfy both seemingly contradictory needs.

The solution is can be referred to as “daisy-chained” value investment shares. In one embodiment, that the initial period for a value investment share is one year. During this year there is a stated index multiple. This means if the index went up, e.g., 4%, then the return on the value investment share is 4%×2, or 8%.

At the end of the year, the investor finds out if the homeowner is able to and plans to repay the investor the original value investment share amount adjusted by the index change times the multiple (there may also be a fixed “security” fee due). If the homeowner indicates that they are repaying, then the transaction can be accomplished for the value investment share. If they say they are not able to repay, the investor can ask them if they want to renew or extend into the future. In some embodiments, a second-year term can be already laid out in the original signed docs and recorded in the system 100. These terms may be somewhat more attractive to the investor, such as with a higher multiple (e.g., 2.5) plus an “Index Addition.” This would be a percent that would be added to the actual index change at the end of the second year. This addition amount can be based on the last calendar 3-month index change, for example. If the index is going up rapidly, e.g., at an annualized rate of 5% or more, the addition is 0%. But if the index is going up only 1%, the addition could be 4% to make their chances of the actual index plus the addition more likely to be at around 5%. If the index is going down at a rate of 5%, the addition would be 10%. That could be set as the maximum. This means that if the actual index the next year went down 11%, the investor would still lose money (in this case (10%−11%)×2=−2%.

If the homeowner cannot: a) pay the mortgage and the value investment share back, b) does not plan to sell, and c) refuses the value investment share renewal terms, the system 100 could be configured to implement a “plan B” to avoid taking the house, wherein: the homeowner agrees to move out, they are helped to find suitable housing, allow the investor or a third party manage the house as an investment property still co-owned with the homeowner. The homeowner would be provided additional cash of, for example, 10% of the house value and a guaranteed return of, for example, 4% of the house value per year. The investor would lease the house out to a renter and keep the remaining rental income if any. At end of each year the homeowner could have the option of moving back in if they can get a mortgage and buyout the investor. The indexed value sharing would continue, possibly with adjustments to account for the increased risk and work of the investor. This could be done on a personal basis, but more likely through a professional property management company. The mortgage would keep amortizing, so eventually the original mortgage will be zero. At this point, it may become even more feasible for the homeowner to finance out the investor and move back into the home.

In various embodiments, if the homeowner refuses all these options, then and only then can the investor foreclose. This rule has the benefit of avoiding foreclosure except extreme case that the refusing to help themselves by selling and accessing what is hopefully a lot of equity, refusing help from the investor if they just cannot bring themselves to sell, and plans on staying in the home putting their mortgage and the bank at further risk. This feature protects the value investment product as well, since homeowners only lose their house to a value investment share investor when the homeowner is refusing reasonable ways to avoid foreclosure/sale of the home.

Alternatively, if the homeowner does accept the renewal, the investor is almost always assured an attractive investment even in a down market because if the home is falling in value, the investor gets the rate of decline added to their next index plus 5%, so if the rate of decent does stay the same, the effective index will be +5%, and the multiple is 2.5, giving the investor a 12.5% return. Given this feature, it is also more likely the investor can sell the value investment share to another investor, e.g., through the system 100, which can have or feed a trading platform.

Therefore, while the investor might be stuck for more than a year, they have a very good chance of either not minding or being able to sell to another investor. This process can go on for any number of years as long as there is sufficient equity in the home to keep the investment safe. In some embodiments, the maximum LTV (loan-to-value ratio) is capped (or has an upper limit or threshold) of around 65% to manage risk, meaning the investor has a reasonable assurance that they can get paid back.

Value Investment Shares Mortgage Servicer

1. What it is:
i. This is a bank account holding cash
ii. A Servicer provides Value Investment Share Servicing Requirements
iii. It is used to pay a homeowners' monthly mortgage and one time catch up as needed forbearance

2. Amount paid towards interest is tax deductible

3: Report allocation of interest paid between homeowner and investor

4. Above benefits increase demand and can lead to quick liquidity for value investment shares.

5: How:
i. Maintain ledger of all value investment shares
ii. Flow cash into value investment shares so the cash ends up with the value investment share Servicers
iii. During life of value investment shares, all value investment shares in existence are on an electronic bulletin board or platform and subject to bidding:
   a. Listed and sellable as distinct value investment shares
   b. value investment shares can be offered and/or grouped in various classes

All owners of value investment shares, of both distinct value investment shares and various classes, can set their transaction status in the system 100, e.g.,: Don't bother me, limit order, market order. Trading functions so bids, asks, and trades can be seen and facilitated. Functionality can be provided so owners can be changed without needing to move cash already with Servicers:
i. people exchange cash outside the Servicer system
ii. owner of record changes
iii. Servicer knows who to send money and info to via ledger, which is maintained and current

People can trade (electronically though a GUI) a bundle of value, e.g., cash sitting in bank. The cash can be reduced monthly and be turned into tax deductions, indexed value investment shares, etc. In an embodiment, if you own value investment shares you can get insurance on $250,000 in escrow.

Servicer Required Documents & Information

Documents and information required/ requested by a Servicer, which can be necessary or useful for establishing the Servicer role and responsibilities, can include, as examples:

Dollar amount invested by the investor.

A copy of all value investment share documents signed by the investor and the homeowner

A copy of the lien filed protecting the value investment share

Title insurance, if any

The formula for calculating the value investment share payoff amount

The homeowner can give consent to obtain information from current lender/servicer, such as:
i. Total amount due
ii. Total amount in forbearance
iii. Exact amount of principal and interest allocation each month
iv. All terms in our data dictionary format

The homeowner can also give permission to communicate with the Servicer with respect to servicing questions.

A copy of all value investment share documents signed by the investor and the homeowner

A copy of the lien filed protecting the value investment share

Title insurance, if any

The formula for calculating the payoff amount for the value investment share

Servicer Job Beyond Normal Servicing

In various embodiments, the Servicer may perform one or more of the following functions.

Send the homeowner their value investment share statement each month, which could include one or more of the following:
i. Look up index number of deal docs
ii. Look up index from index source/provider via, for example, API
iii. Look up or electronically access the value investment share formula in deal docs
iv. Calculate results
v. Report to homeowner and investor
vi. Report to BD exchange
vii. Report tax allocation monthly
viii. Report balance remaining available for value investment share

Can there be more than available? Even if no, can plan on selling it as fully committed.

Communicate to the homeowner their options at the end of the value investment share relationship and/or commitment

Determine and/or issue pay-off amount

If the homeowner is able to obtain a new mortgage, if necessary, provide documentation evidencing the value investment share transaction(s)

In some embodiments, the Servicer can direct the total value investment share payment back to the investor or to the Packager.

What if the investor does not make necessary investment? This can be communicated to the bank, Servicer, and homeowner. In some embodiments, there can be a one or more potential backup investors, e.g., a pool of potential back-up investors available to enter a value investment share relationship.

Various Ways Value Investment Shares can be Created

Value investment shares can be created in various ways, in various embodiments. Some examples are provided below.

I. A Packager Acting as an Investor Produces a Value Investment Share

### EXAMPLES

i. a bank working with their own first mortgage homeowner
ii. an agent finds a homeowner via lead generation, makes investment then places Valshare with the Servicer.

II. A Packager Arranges Between One Investor and One Homeowner

### EXAMPLE

i. Packager introduces agent to homeowner. Agent finds an investor, e.g., a bank
ii. Agent, on behalf of a bank, offers homeowner(s) value investment share opportunity(ies)

In some embodiments, therefore, cash into an escrow account of a homeowner and associated with the property and/or mortgage can include one or more of the following types, uses, and/or designations:
i. Catch-up with mortgage payments (indexed)
ii. Cash towards future mortgage payments (indexed)
iii. Extra cash, Not indexed
iv. Other

Depending on the structure of the value investment share agreement, one or more of the above can be depleted over time. A value investment share formula can account for uses depletion, and/or adjustment of each type above by system 100 processors. For example, one or more type can be index adjusted, but not necessarily by the same index or, if by the same index, not necessarily by the same weighting. Such parameters would be built into the value investment share formula implemented by the system 100, having access to the relevant indices, for automated adjustment and calculation.

The value generated by the value investment share formula at end of deal can be the value investment share dollar amount designated for property related financial obligations (e.g., mortgage) adjusted by at least one index, plus whatever is left in escrow account, e.g., the additional amount. That is, additional amount can be added to a calculated value investment share amount at the end of payoff, e.g., when the homeowner sells the property, refinances, or pays off the mortgage.

While the foregoing has described what are considered to be the best mode and/or other preferred embodiments, it is understood that various modifications can be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

It is appreciated that certain features of the invention, which are, for clarity, described in the context of separate embodiments, may also be provide in combination in a single embodiment. Conversely, various features of the invention which are, for brevity, described in the context of a single embodiment may also be provided separately or in any suitable sub-combination.

For example, it will be appreciated that all of the features set out herein can combined in any given way.

What is claimed is:

1. A computerized equity investment management method, comprising:
providing a networked computer system having at least one processor configured to access at least one storage device; and
the at least one processor, for each of a plurality of subject properties:
generating a digital ledger to store property information in the at least one storage device, including storing a property identification, a property owner identification, and an existing loan amount associated with a subject property in the digital ledger;
electronically determining a market value for the subject property and storing the market value in the digital ledger;
calculating an equity investment amount that is not greater than the market value less the loan amount;
conducting an equity investment transaction comprising:
defining a term and an index representing a change in the market value of the subject property;
transferring the equity investment amount from an investor account to an account associated with the property owner identification; and
updating the digital ledger to associate an investor identification, equity investment amount, term, and index with the subject property as an equity investment;
at a term end, calculating an investor payout by adjusting the equity investment amount by the index; and
generating computer displays from the digital ledger, the computer displays including the equity investment amount, the term, and the index.

2. The method of claim 1, wherein the digital ledger is a distributed digital ledger having property information distributed across a plurality of storage devices.

3. The method of claim 1, further comprising encrypting the digital ledger.

4. The method of claim 1, further comprising the at least one processor:
calculating a loan to value (LTV) ratio for the subject property as a ratio of the existing loan amount to the market value; and
comparing the calculated LTV to a threshold LTV and if the calculated LTV exceeds the threshold LTV terminating the method before calculating the equity investment amount.

5. The method of claim 4, wherein the LTV threshold is eighty percent.

6. The method of claim 1, wherein transferring the equity investment amount from the investor account to the account associated with the property owner identification includes the at least one processor:
calculating an escrow amount as a multiple of monthly mortgage payment associated with the loan amount; and
transferring the escrow amount, as at least a portion of the equity investment amount, to an escrow account.

7. The method of claim 6, further comprising the at least one processor:
in response to a communication from a mortgage lender system of a past due mortgage loan payment, electronically transferring an amount equal to the past due mortgage loan payment from the escrow account to a mortgage lender system.

8. The method of claim 1, wherein electronically determining the market value for the subject property comprises the at least one processor:
generating an electronic query to an automated valuation system requesting the market value for the subject property;
receiving an electronic response including a received automated valuation market value; and
storing the received automated valuation market value as the market value in the digital ledger.

9. The method of claim 1, wherein electronically determining the market value for the subject property comprises the at least one processor:
querying remote systems comprising property sales and/or listing data for properties comparable to the subject property, wherein determining comparable properties includes identifying properties have having similar listing attributes within a zip code; and
calculating the market value from the sales and/or listing data for the properties comparable to the subject property.

10. The method of claim 9, wherein the similar listing attributes includes: number of bedrooms, number of bathrooms, and dwelling type, wherein dwelling type is chosen from a group consisting of single family, multi-family, condominium, and cooperative.

11. The method of claim 1, further comprising the at least one processor:
for each of one or more of the subject properties, defining a share representing the equity investment associated with the subject property;
associating the share with the digital ledger for the subject property; and
hosting an online trading platform to offer, buy, and sell of the shares.

12. The method of claim 11, further comprising the at least one processor:
updating the digital ledger with a new investor identification in response to a sale of share by a new investor.
